(19) United States
(12) Patent Application Publication
(10) Pub. No.: US 2011/0279437 A1
(43) Pub. Date: Nov. 17, 2011

(54) Organic light emitting display and driving method thereof

(76) Inventors: Naoaki Komiya, Yongin-City (KR); Choon-Yul Oh, Yongin-city (KR); Ho-Ryun Chung, Yongin-city (KR); Myoung-Hwan Yoo, Yongin-city (KR); Joo-Hyeon Jeong, Yongin-city (KR); Wang-Jo Lee, Yongin-city (KR); In-Ho Choi, Yongin-city (KR); Chang-Ho Hyun, Yongin-city (KR); Woung Kim, Yongin-city (KR)

(21) Appl. No.: 12/929,285

(22) Filed: Jan. 12, 2011

(30) Foreign Application Priority Data
May 11, 2010 (KR) 10-2010-0044160

(51) Int. Cl. G09G 5/00; G09G 3/30

(52) U.S. Cl. 345/212; 345/76

(57) ABSTRACT

An organic light emitting diode (OLED) display and a driving method thereof include an OLED, a driving transistor supplying a driving current to the OLED, a data line transmitting a data signal to the driving transistor, a first switch including a first electrode connected to one electrode of the OLED and a second electrode connected to the data line, and a second switch including a first electrode connected to the data line and a second electrode connected to the gate electrode of the driving transistor. The first switch is turned on such that a predetermined first current is transmitted to the OLED, the voltage of one electrode of the OLED is received through the data line, the deterioration degree of the OLED is detected according to the transmitted voltage, and the data signal transmitted to the data line is compensated according to the detected deterioration.

### BACKGROUND

1. Field

Embodiments relate to an organic light emitting diode (OLED) display and a driving method thereof. More particularly, embodiments relate to an organic light emitting diode (OLED) display and a driving method realizing external compensation for a driving voltage of an organic light emitting element in real-time according to deterioration of the organic light emitting element in a display device driven by a simultaneous emission type method for an entire display panel.

2. Description of the Related Art

Various kinds of flat display devices that are capable of reducing detriments of cathode ray tubes (CRT), such as their heavy weight and large size, have been developed in recent years. Such flat display devices include liquid crystal displays (LCDs), field emission displays (FEDs), plasma display panels (PDPs), and organic light emitting diode (OLED) displays.

Among the above flat panel displays, the OLED display using an organic light emitting diode OLED generating light by a recombination of electrons and holes for the display of images has a fast response speed, is simultaneously driven with low power consumption, and has excellent luminous efficiency, luminance, and viewing angle such that it has been spotlighted.

Generally, the organic light emitting diode OLED display is classified into a passive matrix OLED (PMOLED) and an active matrix OLED (AMOLED) according to a driving method of the organic light emitting diode OLED.

In the passive matrix OLED, an anode and a cathode intersect to form each pixel, and cathode lines and anode lines are selectively driven. In the active matrix OLED, a thin film transistor and a capacitor are integrated in each pixel and a voltage is maintained by a capacitor. The passive matrix type has a simple structure and a low cost; however it is difficult to realize a panel of a large size or high accuracy. In contrast, with the active matrix type it is possible to realize a panel of a large size or high accuracy, however it is difficult to technically realize the control method thereof and a comparatively high cost is required.

In aspects of resolution, contrast, and operation speed, the current trend is toward the organic light emitting diode display (AMOLED) of the active matrix type where respective unit pixels selectively turn on or off.

One pixel of the active matrix OLED includes the organic light emitting diode OLED, a driving transistor controlling a current amount supplied to the organic light emitting diode OLED, and a switching transistor transmitting a data signal controlling a light emitting amount of the organic light emitting diode OLED to the driving transistor.

The driving transistor has to be continuously turned on so that the organic light emitting diode emits light. If the driving signal is continuously supplied to the gate electrode of the driving transistor, the threshold voltage (Vth) increases and the current flowing decreases over time. If this phenomenon continuously proceeds, the performance of the driving transistor may deteriorate and the organic light emitting diode (OLED) may not normally emit.

The above information disclosed in this Background section is only for enhancement of understanding of the background of the invention and therefore it may contain information that does not form the prior art that is already known in this country to a person of ordinary skill in the art.

### SUMMARY

An organic light emitting diode (OLED) display according to an exemplary embodiment includes a display unit having a plurality of pixels and a plurality of data lines transmitting a data signal to the plurality of pixels.

The plurality of pixels include: an organic light emitting diode (OLED); a driving transistor supplying a driving current to the organic light emitting diode (OLED); a data line transmitting a data signal corresponding to the driving transistor; a first switch including a first electrode connected to one electrode of the organic light emitting diode (OLED) and a second electrode connected to the data line; and a second switch including a first electrode connected to the data line and a second electrode connected to the gate electrode of the driving transistor.

The data lines corresponding to the plurality of pixels among the plurality of data lines transmit the data signal corresponding to the driving transistor.

The first switch is turned on such that a predetermined first current is transmitted to the organic light emitting diode (OLED), the voltage of one electrode of the organic light emitting diode (OLED) is received through the data line, the deterioration degree of the organic light emitting diode (OLED) is detected according to the transmitted voltage, and the data signal transmitted to the data line is compensated according to the detected deterioration. The compensated data signal may be transmitted to the corresponding data lines through the data driver of the organic light emitting diode (OLED) display.

The organic light emitting diode (OLED) display according to an exemplary embodiment may include a scan driver generating and transmitting a scan signal to the corresponding scan line among the plurality of scan lines connected to the plurality of pixels.

A light emission control driver generating and transmitting a light emission control signal to the corresponding light emission control line among the plurality of light emission control lines connected to the plurality of pixels may be included. The light emission control driver may not be separately from other drivers, e.g., may be combined with the scan driver.

The threshold voltage control signal may be generated in the scan driver or an additional driver and transmitted to the corresponding threshold voltage control line among the plurality of threshold voltage control lines connected to the plurality of pixels.

The organic light emitting diode (OLED) display according to an exemplary embodiment may further include a sensing driver configured to generate a detection signal controlling the switching operation of the first switch and transmit the detection signal to the corresponding sensing line among the plurality of sensing lines connected to the plurality of pixels.

The period for turning on the first switch may be a predetermined period among one frame period. One frame period may include a reset period for resetting the driving voltage of the organic light emitting diode (OLED), a threshold voltage compensation period for compensating the threshold voltage of the driving transistor, a data writing period for transmitting the data voltage according to the data signal, and a light emitting period in which the organic light emitting diode (OLED) emits light.

The predetermined period may be before the reset period, however it is not limited thereto, and it may be a predetermined period among one frame period. The predetermined period may be arbitrarily determined or may be determined as a predetermined time among the frame period.

The second switch and the driving transistor may be turned off during a period in which the first switch is turned on.

The organic light emitting diode (OLED) display may further include an image compensator receiving the voltage of one electrode of the organic light emitting diode (OLED) through the data line, and a selection switch positioned between the data line and the image compensator and turned on by the selection signal thereby transmitting the voltage of one electrode to the image compensator.

The second switch may be turned on during the reset period for resetting the driving voltage of the organic light emitting diode (OLED) and the threshold voltage compensation period for compensating the threshold voltage of the driving transistor among one frame period.

The organic light emitting diode (OLED) display may further include a storage capacitor including one terminal connected to the gate electrode of the driving transistor and the other terminal connected to one electrode of the organic light emitting diode (OLED). The storage capacitor charges the data voltage during the data writing period in which the second switch is turned on such that the data voltage according to the data signal is transmitted among one frame period.

The organic light emitting diode (OLED) display may further include a third switch including a first electrode connected to the first power source voltage and a second electrode connected to the source electrode of the driving transistor, and the third switch is turned on during the reset period for resetting the driving voltage of the organic light emitting diode (OLED), the threshold voltage compensation period for compensating the threshold voltage of the driving transistor, and the light emitting period in which the organic light emitting diode (OLED) emits the light among one frame period.

The organic light emitting diode (OLED) display may further include a threshold voltage transistor including a first electrode connected to the gate electrode of the driving transistor and a second electrode connected to the source electrode of the driving transistor, and the threshold voltage transistor is turned on during the threshold voltage compensation period for compensating the threshold voltage of the driving transistor among one frame period.

An organic light emitting diode (OLED) display according to an exemplary embodiment of the present invention includes: a plurality of pixels respectively including a plurality of organic light emitting diodes (OLED); a plurality of data lines transmitting a data signal corresponding to the plurality of pixels; and an image compensator receiving each driving voltage of the plurality of organic light emitting diodes (OLED) through the corresponding data lines during a period in which a predetermined first current flows in the plurality of organic light emitting diodes (OLED), wherein the image compensator determines a deterioration degree of the plurality of organic light emitting diodes (OLED) according to the transmitted driving voltage and compensates a plurality of data signals transmitted to the plurality of pixels according to the determined deterioration degree.

The organic light emitting diode (OLED) display may further include a sensing driver generating and transmitting a detection signal corresponding to a plurality of sensing lines connected to the plurality of pixels, and the plurality of pixels transmit the predetermined first current in response to the detection signal and include a first switch transmitting the driving voltage of the organic light emitting diode (OLED).

The first switch may be turned on during a predetermined period among one frame period, and one frame period includes a reset period for resetting the driving voltage of the organic light emitting diode (OLED), a threshold voltage compensation period for compensating the threshold voltage of the driving transistor, a data writing period for transmitting the data voltage according to the data signal, and a light emitting period in which the organic light emitting diode (OLED) emits light.

The predetermined period may be before the reset period.

The plurality of pixels include a second switch transmitting a compensated data signal through the corresponding data line among the plurality of data lines, a driving transistor supplying the driving current according to the compensated data signal to the organic light emitting diode (OLED), and a third switch positioned between the first power source voltage and the driving transistor and controlling the light emitting of the organic light emitting diode (OLED).

The plurality of pixels may include a second switch transmitting a compensated data signal through the corresponding data line among the plurality of data lines, a driving transistor supplying the driving current according to the compensated data signal to the organic light emitting diode (OLED), and a threshold voltage transistor diode-connecting the driving transistor to charge the threshold voltage of the driving transistor to a capacitor connected to the gate electrode of the driving transistor.

The plurality of pixels may include a storage capacitor connected between the gate electrode and the source electrode of the driving transistor, and the method may include charging the data voltage corresponding to the compensated data signal in the storage capacitor during a period in which the second switch is turned on among one frame period.

The second switch is turned on during the reset period for resetting the driving voltage of the organic light emitting diode (OLED) and the threshold voltage compensation period for compensating the threshold voltage of the driving transistor among one frame period.

The organic light emitting diode (OLED) display may further include a data selection unit including a selection switch connected to the data lines respectively connected to the plurality of pixels and selecting a path of the voltage transmitted through the data lines, the method including turning on the selection switch by the selection signal such that the driving voltage of the organic light emitting diode (OLED) is transmitted to the image compensator.

A method for driving an organic light emitting diode (OLED) display including a plurality of pixels respectively including a plurality of organic light emitting diodes (OLED), a plurality of data lines transmitting a data signal corresponding to the plurality of pixels, and an image compensator receiving each driving voltage of the plurality of organic light emitting diodes (OLED) through the corresponding data lines during a period in which a predetermined first current flows in the plurality of organic light emitting diodes (OLED) according to an exemplary embodiment includes: receiving the driving voltage of the plurality of organic light emitting diodes (OLED) through the data lines; determining a deterioration degree of the plurality of organic light emitting diodes (OLED) according to the transmitted driving voltage; and compensating the plurality of data signals transmitted to the plurality of pixels according to the determined deterioration degree.

Receiving, determining, and compensating may be executed during a predetermined period of one frame period a predetermined period of one frame period.

One frame period may include a reset period for resetting the driving voltage of the organic light emitting diode (OLED), a threshold voltage compensation period for compensating the threshold voltage of the driving transistor, a data writing period for transmitting the data voltage according to the data signal, and a light emitting period in which the organic light emitting diode (OLED) emits light.

The predetermined period may be before the reset period.

A first switch of the plurality of pixels flowing a first predetermined current to the organic light emitting diode (OLED) included in the plurality of pixels and transmitting the driving voltage of the organic light emitting diode (OLED) to the corresponding data line may be turned on during a period in which the receiving, determining, and compensating are executed.

The plurality of pixels may include a second switch transmitting a compensated data signal through the corresponding data line among the plurality of data lines, a driving transistor supplying the driving current according to the compensated data signal to the organic light emitting diode (OLED), and a third switch positioned between the first power source voltage and the driving transistor and controlling the light emitting of the organic light emitting diode (OLED). The method may include turning off the second switch, the driving transistor, and the third switch during the period in which the driving voltage sensing step and the compensation step are executed.

The plurality of pixels may include a second switch transmitting a compensated data signal through the corresponding data line among the plurality of data lines, a driving transistor supplying the driving current according to the compensated data signal to the organic light emitting diode (OLED), and a threshold voltage transistor diode-connecting the driving transistor to charge the threshold voltage of the driving transistor to a capacitor connected to the gate electrode of the driving transistor. The method may include turning off second switch, the driving transistor, and the threshold voltage transistor during the period in which the receiving, determining, and compensating are executed.

The plurality of pixels may include a storage capacitor connected between the gate electrode and the source electrode of the driving transistor, and the storage capacitor charges the data voltage corresponding to the compensated data signal during a period in which the second switch is turned on among one frame period.

The method may include turning on the second switch during the reset period for resetting the driving voltage of the organic light emitting diode (OLED) and the threshold voltage compensation period for compensating the threshold voltage of the driving transistor among one frame period.

The organic light emitting diode (OLED) display may further include a data selection unit including a selection switch connected to the data lines respectively connected to the plurality of pixels and selecting a path of the voltage transmitted through the data lines.

The method may include turning on the selection switch by the selection signal such that the driving voltage of the organic light emitting diode (OLED) is transmitted to the image compensator.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an organic light emitting diode (OLED) display according to an exemplary embodiment.

FIG. 2 illustrates a driving timing diagram showing pixel driving of a simultaneous emission type in an organic light emitting diode (OLED) display according to an exemplary embodiment.

FIG. 3 illustrates a circuit diagram of a pixel shown in FIG. 1 according to an exemplary embodiment.

FIG. 4 illustrates a driving timing diagram for driving a pixel of an organic light emitting diode (OLED) display of FIG. 1 according to an exemplary embodiment.

FIG. 5 illustrates a detailed driving timing diagram for a driving voltage sensing and data compensation period of FIG. 4.

FIG. 6 illustrates a circuit diagram of the pixel of FIG. 1 according to another exemplary embodiment.

### DETAILED DESCRIPTION

Korean Patent Application No. 10-2010-0044160, filed on May 11, 2010, in the Korean Intellectual Property Office, and entitled: “Organic Light Emitting Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Further, in the exemplary embodiments, constituent elements having the same construction are assigned the same reference numerals and are representatively described in connection with a first exemplary embodiment. In the remaining embodiments, only constituent elements that are different from those of the first exemplary embodiment are described. Wherever possible, the same reference numbers will be used throughout the drawings to refer to the same or like parts.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

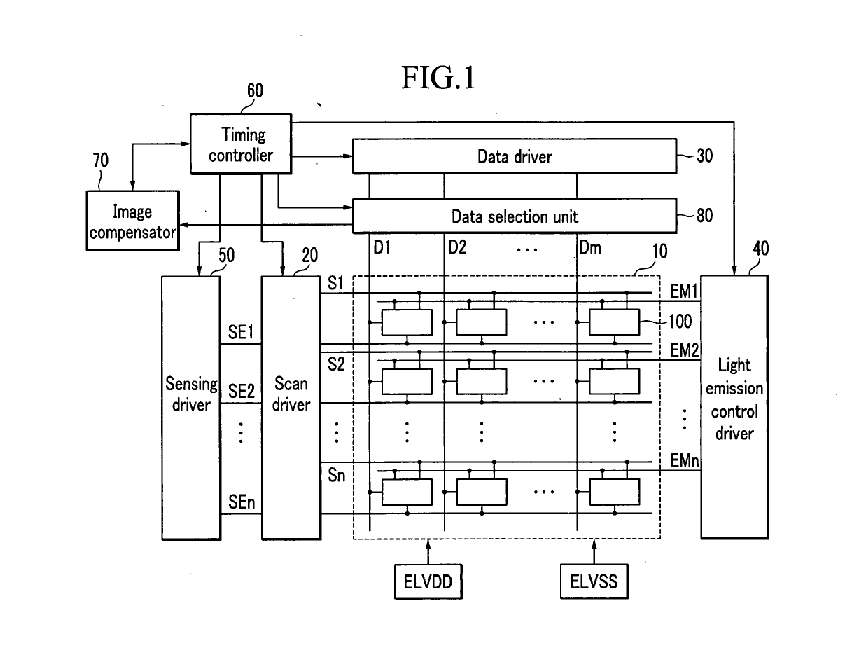

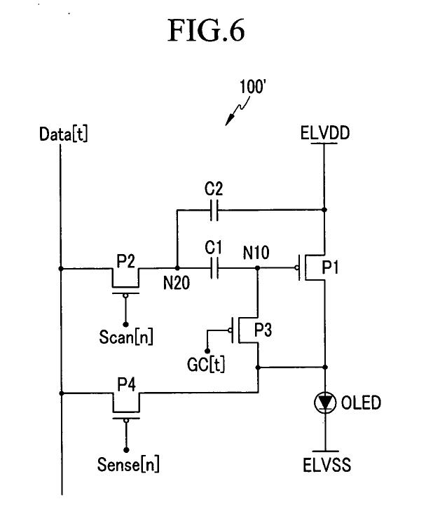

FIG. 1 illustrates a block diagram of an organic light emitting diode (OLED) display according to an exemplary embodiment. Referring to FIG. 1, an organic light emitting diode (OLED) display according to an exemplary embodiment of the present invention includes a display unit 10 in which a plurality of scan lines S1 to Sn, a plurality of light emission control lines EM1 to EMn, a plurality of sensing lines SE1 to SEn, and a plurality of data lines D1 to Dm intersect each other, and a plurality of pixels 100 of the display unit 10 are connected to the corresponding scan lines, light emission control lines, sensing lines, and data lines. Details of structure and operation of the pixel 100 will be described with reference to FIG. 3 and FIG. 6.

In the exemplary embodiment, the organic light emitting diode (OLED) display includes the display unit 10, a scan driver 20, a sensing driver 50, a light emission control driver 40, a data driver 30, a data selection unit 80, and an image compensator 70. However, embodiments are not limited to this configuration, and a predetermined driver generating a driving control signal controlling a switching operation of a transistor and transmitting it to a transmitting line may be added according to the configuration of the circuit of the pixel 100.

The scan driver 20 generates a plurality of scan signals and transmits them to a plurality of scan lines S1 to Sn.

The light emission control driver 40 generates a plurality of light emission control signals and supplies them to a plurality of light emission control lines EM1 to EMn.

The data driver 30 transmits a plurality of data signals to a plurality of data lines D1 to Dm.

The sensing driver 50 generates a plurality of detection signals and transmits them to a plurality of sensing lines SE1 to SEn.

A timing controller 60 controls the scan driver 20, the sensing driver 50, the light emission control driver 40, and the data driver 30.

The data selection unit 80 includes a selection switch (not shown) respectively connected to a plurality of data lines D1 to Dm. The selection switch controls the switching operation in response to the selection signal transmitted from the timing controller 60, and selects a transmitting path of a corresponding voltage through the plurality of data lines D1 to Dm to transmit them.

In further detail, the selection switch may transmit the data signals for light emission of the plurality of pixels from the data driver 30 to the display unit 10 through the plurality of data lines D1 to Dm. Also, the selection switch may be turned on by the selection signal during a predetermined period of one frame period such that the driving voltage of the each organic light emitting diode (OLED) of the plurality of pixels may be transmitted to the image compensator 70 through the corresponding data lines among the plurality of data lines D1 to Dm.

The image compensator 70 receives the driving voltage of the organic light emitting diode (OLED) sensed in the plurality of pixels 100 included in the display unit 10 during the predetermined period to determine a compensation amount of the data voltage. That is, the image compensator 70 senses the driving voltage from the organic light emitting diode (OLED) of each pixel 100 of the display unit 10 in real time, and detects the sensed driving voltage and the resistance of the organic light emitting diode (OLED) according to the sensed driving voltage to determine the deterioration degree. The image compensator 70 determines a data voltage compensation amount according to the deterioration degree of the organic light emitting diode (OLED). If the organic light emitting diode (OLED) is deteriorated, the luminous efficiency is decreased. Thus, the amount of light emitted decreases, even when the same current flows. The data voltage compensation amount according to an exemplary embodiment means the compensation amount to compensate for the decreased light emitted according to the deterioration degree.

The image compensator 70 may calculate the resistance of the organic light emitting diode (OLED) using the current supplied to the organic light emitting diode (OLED) and the driving voltage of the organic light emitting diode (OLED). The resistance changes according to the deterioration degree of the organic light emitting diode (OLED), and generally increases when the deterioration degree is significant.

The image compensator 70 may store the data voltage compensation amount corresponding to the resistance of the organic light emitting diode (OLED) as a lookup table, and may further include a memory unit including the lookup table. The data voltage compensation amount may be transmitted from the image compensator 70 to the timing controller 60. The timing controller 60 compensates the image data signal according to the video signal transmitted from the outside based on the transmitted compensation amount.

The compensated image data signal is transmitted to the data driver 30, and the data driver 30 transmits the plurality of data signals according to the compensated image data signal to the plurality of pixels of the display unit 10. Thus, the current supplied to the organic light emitting diode (OLED) is increased to compensate for the deterioration. Thus, the organic light emitting diode (OLED) may emit light of appropriate luminance, i.e., a luminance output before deterioration.

The non-uniformity and the image deterioration of the display screen due to deterioration of the organic light emitting diode (OLED) in each pixel 100 of the display unit 10 typically arise after a long operational period of the display screen. However, the real driving voltage is sensed and compensated in real time to suppress the image sticking in the display screen such that the clear and correct image quality may be realized.

The display unit 10 includes the pixels 100 disposed in at intersections of the plurality of scan lines S1 to Sn, the plurality of sensing lines SE1 to SEn, the plurality of light emission control lines EM1 to EMn, and the plurality of data lines D1 to Dm. The pixels 100 receive the first power source voltage ELVDD and the second power source voltage ELVSS from the outside.

The pixels 100 supply the current to the organic light emitting diode (OLED) according to the corresponding data signal, and the organic light emitting diode (OLED) emits light of a predetermined luminance according to the supplied current.

In the case of the organic light emitting diode (OLED) display according to an exemplary embodiment of the present invention shown in FIG. 1, the first power source voltage ELVDD applied in each pixel 100 of the display unit may be maintained as the predetermined voltage during the period of one frame.

On the other hand, the supplied voltage values of the first power source voltage ELVDD may be different according to a reset period for resetting the driving voltage of the organic light emitting diode (OLED) during one frame period, a threshold voltage compensation period for compensating the threshold voltage of the driving transistor, a data writing period in which the data signal is transmitting and written, and a light emitting period in which all pixels emit light at the same time after the writing of the data signal corresponding to the pixel is completed. To control the different voltage value of the first power source voltage ELVDD for the period of one frame, a power source driver controlling the supply of the first power source voltage ELVDD may be further included.

The timing controller 60 may generate the control signal controlling the power source driver and transmit it to the power source driver.

However, embodiments are not limited thereto. For example, the power source driver may control the supply of the second power source voltage ELVSS for the voltage value of the predetermined level to be applied to each pixel during one frame period as well as the first power source voltage ELVDD.

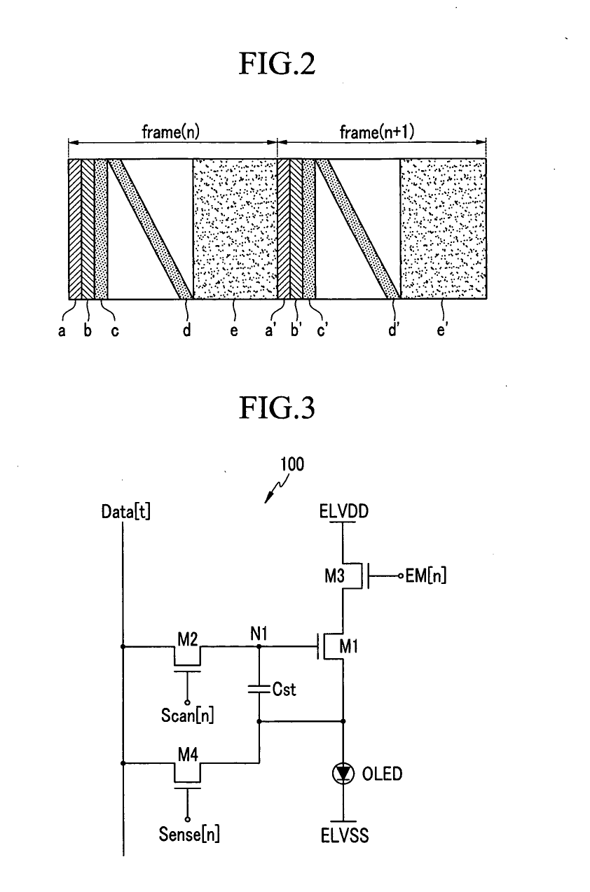

The organic light emitting diode (OLED) display according to an exemplary embodiment may be driven by a simultaneous light emission method. As shown in FIG. 2, in the simultaneous light emission method, a period of one frame includes a data writing period in which the corresponding data signal among the plurality of data signals is transmitted and written to all pixels, and a light emitting period in which all pixels emit the light at the same time after the writing of the data signal corresponding to the pixel is completed. In a conventional sequential light emission method, data signals are sequentially input for each scan line and then the light is emitted sequentially. In an exemplary embodiment, data signals are sequentially input for each scan line, but light is emitted simultaneously from all scan lines after all of data signals have been input.

In detail, FIG. 2 illustrates a timing diagram showing the driving process of the n-th frame and the (n+1)-th frame when the driving period according to an exemplary embodiment includes driving voltage sensing and data compensation periods a and a′, reset periods b and b′, threshold voltage compensation periods c and c′, data writing periods d and d′, and light emitting periods e and e′.

In the driving voltage sensing and data compensation periods a and a′, the driving voltage of the organic light emitting diode (OLED) of the plurality of pixels emitting the light is sensed and the compensation amount of the data voltage according to the sensed driving voltage is determined. Referring to the n-th frame, the driving voltage of the organic light emitting diode (OLED) in the plurality of pixels is sensed during the driving voltage sensing and data compensation period a. Also, the resistance of the organic light emitting diode (OLED), which is correlated to the deterioration degree of the organic light emitting diode (OLED), is detected. Then, the data voltage compensation amount in accordance with the decreased amount of the light emitted according to the deterioration degree is determined.

Next, the reset period b for resetting the driving voltage of the organic light emitting diode (OLED) in the plurality of pixels is continuous. If the cathode of the organic light emitting diode (OLED) is fixed as the predetermined voltage during the reset period b, the anode voltage of the organic light emitting diode (OLED) is determined to be less than the cathode voltage such that the driving voltage applied to the organic light emitting diode (OLED) is reset.

The threshold voltage of the driving transistor provided in each pixel 100 may be compensated during the threshold voltage compensation period c. The threshold voltage according to the voltage difference between the gate electrode and the source electrode of the driving transistor may be stored in a storage capacitor.

The plurality of pixels is sequentially scanned for each scan line during the data writing period d in which the plurality of pixels is supplied with the data signal. However, all pixels of the display unit 10 are simultaneously and totally driven during the driving voltage sensing and data compensation period a, the reset period b, the threshold voltage compensation period c, and the light emitting period e.

Finally, during the light emitting period e, each organic light emitting diode (OLED) of all pixels of the display unit of the organic light emitting diode (OLED) display are simultaneously driven corresponding to the data voltage according to the data signal stored during the data writing period d, and emit the light by the corresponding driving current.

According to another exemplary embodiment, a light emitting off period in which the light emitting of the organic light emitting diode (OLED) of the plurality of pixels emitting the light is off after the light emitting periods e and e′ may be further included.

According to the “simultaneous emission” method according to the exemplary embodiment, each of the operations of the periods a to e is simple, and thereby the number of transistors of the compensation circuit provided in each pixel 100 and the signal lines may be reduced.

Without the complicated circuit adding the plurality of transistors to the pixel circuit, the additional period for compensating the image sticking is provided for each frame such that it is possible for the screen to be simply compensated in real time.

The period for compensating the image sticking among each frame may be determined with the predetermined period, and may be arbitrarily determined at the time according to requirements of the user. It is preferable that the period compensating the image sticking is executed at the earlier part of each frame.

Also, the change of the power source voltage supplied from the outside or the timing change of the driving signal are easy during the compensation period of the image sticking.

In the exemplary embodiment of FIG. 2, the plurality of pixels included in the display unit 10 are driven by the simultaneous emission method during one frame period. However, embodiments are not limited thereto. For example, the driving voltage sensing and data compensation period may be divided and driven during a continuous frame period.

The driving voltage sensing and data compensation period a may require a lot of time to detect of the driving voltage of the organic light emitting diode (OLED). Thus, the driving voltage of the organic light emitting diode (OLED) of all pixels included in the display unit may not be detected in one frame. Instead, a plurality of pixel areas included in the display unit may be divided per continuous frame and the driving voltage of the organic light emitting diode (OLED) included in a specific pixel area may be detected. To sense the driving voltage of the organic light emitting diode (OLED) of the plurality of pixels included in the display unit, frames corresponding to the number of the plurality of pixel areas is need.

That is, the plurality of pixel areas may be determined per pixel line, for example the first pixel area may be determined as the plurality of pixels included from the first pixel line to the x-th pixel line, the second pixel area may be determined as the plurality of pixels included from the (x+1)-th pixel line to the y-th pixel line, and the third pixel area may be determined as the plurality of pixels included from the (y+1)-th pixel line to the final pixel line.

Here, to sense driving voltages of organic light emitting diodes (OLEDs) in each of the pixels of the display, the three frame periods are needed. First, driving voltages of organic light emitting diodes (OLEDs) in the pixels included in the first pixel area are sensed during the predetermined period among the first frame. Next, driving voltages of organic light emitting diodes (OLEDs) in the pixels included in the second pixel area and the third pixel area are sensed during the predetermined period of the second frame and the predetermined period of the third frame, respectively.

During the light emitting period in each frame period, the driving voltage is sensed during the corresponding frame period thereby emitting the light corresponding to the compensated data signal, and the light is emitted corresponding to the data signal that is compensated according to the driving voltage of the organic light emitting diode (OLED) that is sensed and stored and divided in the previous frame.

FIG. 3 illustrates a circuit diagram showing a configuration according to an exemplary embodiment of the pixel 100 shown in FIG. 1. Referring to FIG. 3, a pixel 100 according to an exemplary embodiment includes an organic light emitting diode (OLED), a driving transistor M1, a first switch M1, a second switch M2 and a third switch M3.

The organic light emitting diode (OLED) includes an anode connected to the driving transistor M1 and a cathode connected to the second power source voltage ELVSS.

The driving transistor M1 includes a gate electrode connected to a drain electrode of the second switch M2 transmitting the data signal, a source electrode connected to a drain electrode of the third switch M3 controlling the light emission of the pixel, and a drain electrode connected to the anode of the organic light emitting diode (OLED).

The first switch M4 receives the driving voltage of the organic light emitting diode (OLED) from the anode of the organic light emitting diode (OLED). The first switch M4 includes a gate electrode connected to the n-th sensing line among the plurality of sensing lines, a source electrode connected to the anode of the organic light emitting diode (OLED), and a drain electrode connected to the data line corresponding to the pixel.

The first switch M4 receives the detection signal Sense[n] through the sensing line corresponding to the pixel 100 among the plurality of sensing lines, and operates in response to the detection signal Sense[n]. In FIG. 3, the detection signal Sense[n] means the detection signal Sense[n] transmitted from the sensing line connected to the pixel 100 included in the n-th pixel line among the plurality of pixels.

The second switch M2 includes a gate electrode connected to the n-th scan line among the plurality of scan lines, a source electrode connected to the data line receiving the data signal, and a drain electrode connected to the gate electrode of the driving transistor M1. The second switch M2 transmits the data signal to the driving transistor M1 in response to the scan signal Scan[n] transmitted from the corresponding scan line connected to the pixel 100 among the plurality of scan lines. In FIG. 3, the scan signal Scan[n] means the scan signal Scan[n] transmitted from the scan line connected to the pixel 100 included in the n-th pixel line among the plurality of pixels.

The third switch M3 includes a gate electrode connected to the n-th light emission control line among the plurality of light emission control lines, a source electrode connected to the first power source voltage ELVDD, and a drain electrode connected to the source electrode of the driving transistor M1. The third switch M3 controls the light emission of the organic light emitting diode (OLED). The third switch M3 operates in response to the light emission control signal EM[n] transmitted from the light emission control line corresponding to the pixel 100 among the plurality of light emission control lines. In FIG. 3, the light emission control signal EM[n] means the light emission control signal EM[n] transmitted to the light emission control line connected to the pixel 100 included in the n-th pixel line among the plurality of pixels.

In the exemplary embodiment of FIG. 3, the pixel 100 further includes a storage capacitor Cst storing the threshold voltage of the driving transistor M1. The storage capacitor Cst includes a first terminal connected to a first node N1 between the driving transistor and the second switch M2, and a second terminal connected to the anode of the organic light emitting diode (OLED).

The organic light emitting diode (OLED) emits the light with the predetermined luminance corresponding to the driving current according to the data signal supplied from the driving transistor M1.

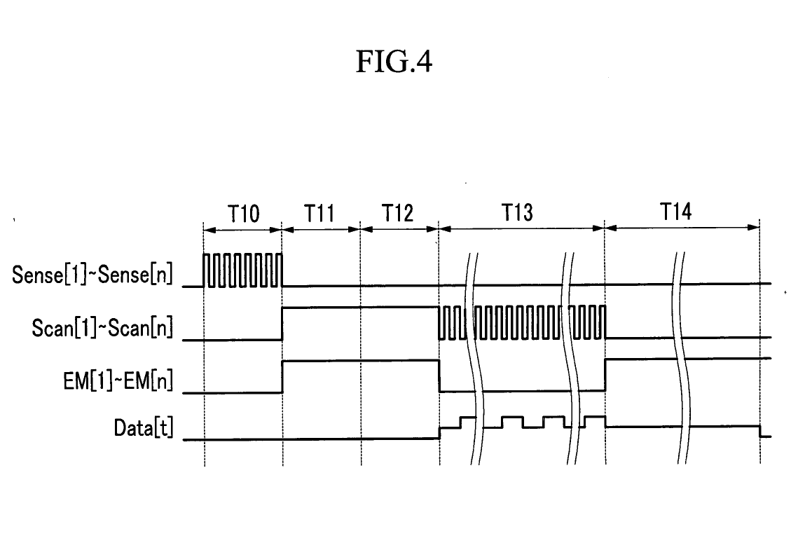

A process of compensating the image sticking in the organic light emitting diode (OLED) display according to the pixel driving timing of FIG. 4 will be described with reference to the driving circuit of the pixel 100 according to an exemplary embodiment of the present invention shown in FIG. 3.

The pixel driving timing diagram of FIG. 4 illustrates the process in which the display unit of the organic light emitting diode (OLED) display according to an exemplary embodiment is driven during one frame.

The display unit of the organic light emitting diode (OLED) display includes a plurality of the pixels 100 according to an exemplary embodiment shown in FIG. 3. The circuit of the pixel 100 as shown in FIG. 3 uses NMOS transistors. The voltage level of the driving signals shown in FIG. 4 is determined to be applied to the pixels configured by the NMOS transistor of FIG. 3. Alternatively, the pixel circuit may be realized using PMOS transistors for which the polarity of the driving waveforms of FIG. 4 may be reversed.

The pixel driving method according to the exemplary embodiment is the simultaneous emission driving method. One frame period includes a driving voltage sensing and data compensation period T10, a reset period T11, a threshold voltage compensation period T12, a data writing period T13, and the light emitting period T14.

The driving voltage sensing and data compensation period T10 may be early within a frame period. In particular, the period T10 may be divided from the other period and compensates for the image sticking such that the power source voltage supplied from the outside and the timing of the driving signals may be easily changed, allowing image sticking to be compensated in real time. Also, the driving voltage of the organic light emitting diode (OLED) is sensed in real time such that the luminous efficiency of the display unit including the pixels may be predicted.

The detection signal is transmitted to the plurality of first switches M4 included in the plurality of pixels 100 of the display unit during the driving voltage sensing and data compensation period T10. The plurality of pixel lines included in the display unit is the n lines, and the detection signal is transmitted through the plurality of sensing lines connected to each pixel line. During the period T10, the detection signal Sense[1] transmitted through the sensing line connected to the first pixel line to the detection signal Sense[n] transmitted through the sensing line connected to the n-th pixel line is transmitted to the plurality of pixels 100 included in the corresponding pixel line.

The detection signals Sense[1]-Sense[n] transmitted to the gate electrode of the first switch M4 of the plurality of pixels 100 of the display unit are high, turning on the gate electrode. Here, the scan signals Scan[1]-Scan[n] transmitted to the gate electrode of the second switch M2 of the plurality of pixels and the light emission control signals EM[1]-EM[n] transmitted to the gate electrode of the third switch M3 of the plurality of pixels are low, turning off the gate electrodes of the second switch M2 and the third switch M3. The data signal Data[t] is maintained as low. Here, the data signal Data[t] is representative of the corresponding data signal respectively transmitted to the plurality of pixels of the display unit at the predetermined time [t] among one frame period.

The first switch M4 of the plurality of pixels 100 is turned on according to the detection signals Sense[1]-Sense[n] during the driving voltage sensing and data compensation period T10. The first predetermined current is supplied to the organic light emitting diode (OLED) from the image compensator of the organic light emitting diode (OLED) display through the first switch M4. The first current is the test current for sensing the deterioration degree of the organic light emitting diode (OLED), and may be arbitrarily determined. For example, current flowing in the organic light emitting diode (OLED) when the data voltage corresponding to a maximum grayscale is supplied to the driving transistor may be determined as the predetermined first current, and current flowing in the organic light emitting diode (OLED) when the data voltage corresponding to an intermediate grayscale or a minimum grayscale may be determined as the predetermined first current.

Here, the current driving voltage of the organic light emitting diode (OLED) is applied to the data lines of the pixels from the source electrode to the drain electrode of the first switch M4 in the plurality of pixels. The current driving voltage is the voltage reflecting the deterioration degree of the organic light emitting diode (OLED).

The driving voltage of the organic light emitting diode (OLED) applied to the data lines is transmitted to the image compensator 70 of the organic light emitting diode (OLED) display according to the exemplary embodiment of the present invention, thereby being used to determine the data voltage compensation amount.

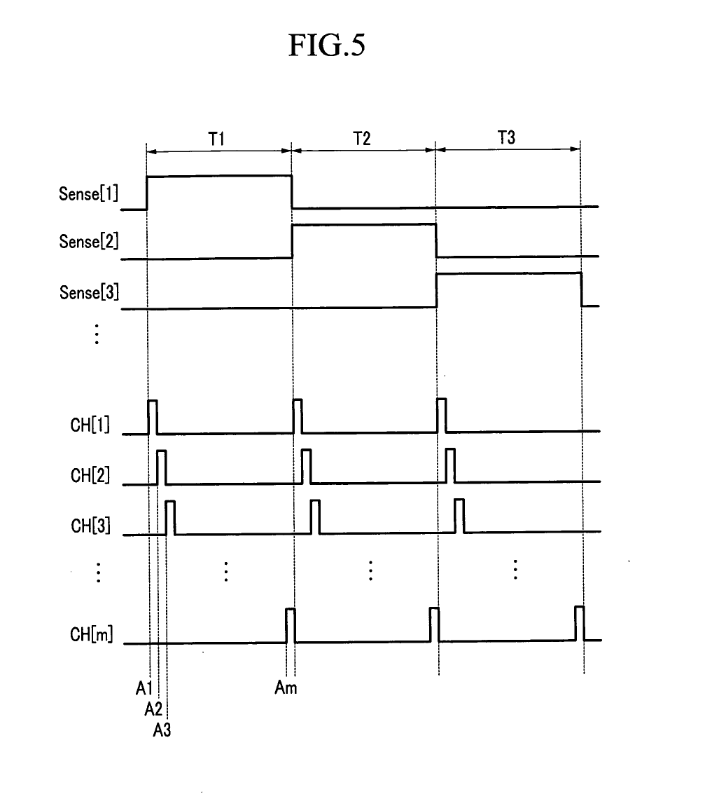

The process will be described with reference to the driving timing diagram of FIG. 5 in further detail. FIG. 5 illustrates a waveform diagram showing a timing relationship of the selection signal CH[m] applied to the plurality of selection switches included in the data selection unit 80 when the plurality of detection signals Sense[1]-Sense[n] generated in the sensing driver 50 of FIG. 1 are sequentially transmitted to the plurality of sensing lines connected to the plurality of pixel lines of the display unit. In other words, the driving timing of the sensing driver 50 executed during the driving voltage sensing and data compensation period T10 of FIG. 4 is shown in detail in FIG. 5.

As shown in FIG. 5, the sensing line connected to the first pixel line among the plurality of pixel lines receives the first detection signal Sense[1] having a predetermined gate-on voltage level during the period T1. The pixel 100 of the exemplary embodiment is realized by NMOS transistors, such that the first detection signal Sense[1] is high during the period T1 to turn on the first switch M4.

The first detection signal Sense[1] is low after the period T1. The second detection signal Sense[2] and the third detection signal Sense[3] are transmitted to the sensing line connected to the second pixel line and the third pixel line as high during the periods T2 and T3, respectively. Hereafter, the plurality of pixels connected to the remaining pixel lines, i.e., the fourth to the final n-th pixel lines, sequentially receive a high detection signal Sense[n]. Here, periods in which the plurality of detection signals are transmitted to the sensing lines connected to each pixel line are equal to each other.

When a corresponding detection signal is high, the first switch M4 of the plurality of pixels connected to that pixel line is turned on and the first current flows to determine the deterioration degree of the organic light emitting diode (OLED), and the driving voltage of the organic light emitting diode (OLED) is transmitted to the corresponding data lines. Thus, the corresponding selection switch among the plurality of selection switches of the data selection unit 80 transmits the driving voltage to the image compensator 70 in response to the selection signal.

The selection signal may be generated in the timing controller 60 and may be transmitted to the data selection unit 80. The timing controller 60 generates the plurality of selection signals and transmits them to the plurality of selection switches included in the data selection unit 80 in synchronization with the corresponding detection signal among the plurality of detection signals generated in the sensing driver 50.

When the plurality of pixels included in the first pixel line are m, the data lines are connected from the first pixel to the m-th pixel, and the data lines are connected to the corresponding selection switches.

The m selection signals CH[1]-CH[m] having the pulse of the voltage level for turning on the m selection switches corresponding to the m pixels are transmitted during the period in which the detection signal is transmitted to the plurality of pixels included in one pixel line.

As one example, the first selection signal CH[1], the second selection signal CH[2], and the third selection signal CH[3] to the m-th selection signal CH[m] are sequentially transmitted from the selection switch corresponding to the first pixel among the plurality of pixels included in the first pixel line at the time A1, the time A2, and the times A3 to Am during the period T1, as shown in FIG. 5.

In the pixel driving timing diagram in FIG. 4, the detection signals Sense[1]-Sense[n] transmitted to the first switch M4 of the plurality of pixels all have the gate off voltage level after the driving voltage sensing and data compensation period T10 such that the plurality of the first switches M4 are turned off and the driving voltage of the plurality of organic light emitting diodes (OLED) are not sensed.

During the reset period T11, the scan signals Scan[1]-Scan[n] transmitted to the gate electrode of the second switch M2 of the plurality of pixels of the display unit and the light emission control signals EM[1]-EM[n] transmitted to the gate electrode of the third switch M3 of the plurality of pixels of the display unit are high, turning on the second switch M2 and the third switch M3 of the plurality of pixels. Accordingly, each of the driving transistors M1 of the plurality of pixels is also turned on.

The first power source voltage ELVDD is low, e.g., almost 0V, and the scan signal Scan[n] is high during the reset period T11, such that the charges accumulated to the anode of the organic light emitting diode (OLED) may be quickly discharged. Accordingly, the driving voltage of the organic light emitting diode (OLED) may be quickly reset.

The next period is the threshold voltage compensation period T12 in which the threshold voltage of the driving transistor M1 provided in the plurality of pixels of the display unit 10 are stored to the storage capacitor Cst has the function of removing the deterioration due to the threshold voltage deviation of the driving transistor when the data voltage is changed in each pixel.

During the threshold voltage compensation period T12, the scan signals Scan[1]-Scan[n] transmitted to the gate electrode of the second switch M2 of the plurality of pixels and the light emission control signals EM[1]-EM[n] transmitted to the gate electrode of the third switch M3 of the plurality of pixels are high, turning on the second switch M2, the third switch M3, and the driving transistor M1 of the plurality of pixels.

During the threshold voltage compensation period T12, the first power source voltage ELVDD is high, and the voltage of the data signal Data[t] that is limited may be applied as the voltage value that represents the threshold voltage deviation of the driving transistor M1 when the data voltage is charged to the pixel or the minimum voltage value to turn on the driving transistor M1.

Here, if the voltage of the cathode of the organic light emitting diode (OLED) is controlled as the predetermined voltage level for the current to not flow in the organic light emitting diode (OLED), the voltage corresponding to the threshold voltage of the driving transistor is charged to the storage capacitor Cst during the threshold voltage compensation period T12.

Next, during the data writing period T13, the scan signals Scan[1]-Scan[n] are sequentially applied for each pixel connected to the plurality of scan lines S1 to Sn of the display unit 10. Thus, the data signals supplied to the plurality of data lines D1 to Dm are transmitted. In FIG. 4, the scan signals Scan[1]-Scan[n] are sequentially high, turning on the second switch M2 during the period T13. FIG. 4 shows the overlapping scan signals.

During the data writing period T13, the scan signals Scan[1]-Scan[n] are sequentially input to the scan lines. Thus, the data signals are sequentially input to the pixels connected per each scan line. The light emission control signals EM[1]-EM[n] are low during this period, such that the third switch M3 of the plurality of pixels is turned off. Accordingly, the first power source voltage ELVDD may be provided as the voltage of any level during this period.

When the scan signal is sequentially high during the data writing period T13, the second switch M2 of the plurality of pixels is sequentially turned on and the data signal having the predetermined various voltage values is sequentially applied to the first node N1 while passing through the source electrode and the drain electrode of the second switch M2.

The voltage of both terminals of the storage capacitor Cst is charged with the voltage corresponding to the threshold voltage of the driving transistor M1 during the threshold voltage compensation period T12 such that the voltage of the first terminal of the storage capacitor Cst connected to the first node N1 is changed according to the change of the data signal voltage during the data writing period T13, and the voltage of the second terminal of the storage capacitor Cst is changed by the voltage corresponding to the change of the data signal from the voltage charged with the threshold voltage.

The third switch M3 of the plurality of pixels is turned off during the data writing period T13 such that a current path is not formed between the organic light emitting diode (OLED) and the first power source voltage ELVDD. Thus, current does not substantially flow in the organic light emitting diode (OLED) of the plurality of pixels, i.e., light is not emitted.

Finally, the organic light emitting diode (OLED) of the plurality of pixels (OLED) emits the light corresponding to the data signal input during the data writing period T13 during the light emitting period T14. That is, the current corresponding to the data signal voltage stored to the plurality of pixels of the display unit 10 flows in the organic light emitting diode (OLED) included in each pixel, thereby executing the light emitting.

During the light emitting period T14, the first power source voltage ELVDD is at the predetermined high level, the scan signals Scan[1]-Scan[n] are low, and the light emission control signals EM[1]-EM[n] are high. Accordingly, the second switch M2 of the plurality of pixels are turned off, and the third switch M3 and the driving transistor M1 are turned on, such that the path of the first power source voltage ELVDD and the current to the cathode of the organic light emitting diode (OLED) is formed.

Accordingly, the current corresponding to the voltage according to the voltage difference between the gate electrode and the source electrode of the driving transistor M1 is applied to the organic light emitting diode (OLED) of the plurality of pixels, and the light of the luminance corresponding thereto is emitted.

As described above, the first switch M4 is only driven during the earlier predetermined period of one frame period to separately determine the period for compensating the image sticking, the pixels are driven through the simultaneous emission type to realize one frame during the periods except for that period, and these processes are repeated to repeatedly realize the following frame.

FIG. 6 illustrates a circuit diagram of a pixel 100′ according to another exemplary embodiment for use in the display unit 10 of FIG. 1. The pixel 100′ of FIG. 6 may be one of the plurality of pixels included in the n-th pixel line among the plurality of pixels configuring the display unit 10 of FIG. 1. In contrast to the pixel driving circuit of FIG. 3, the driving circuit of the pixel 100′ according to the exemplary embodiment of FIG. 6 is realized by PMOS transistors. Accordingly, to turn on gates of the plurality of PMOS transistors configuring the pixel, the switch driving signals are low.

Thus, the driving of the pixel of FIG. 6 may be realized with the driving timing diagram of FIG. 4. Since the timing diagram illustrated in FIG. 4 is for a circuit configured with NMOS transistors, when applied to the driving circuit having PMOS transistors of FIG. 6, the polarity of the driving waveform of FIG. 4 may be inverted and applied. Otherwise, the pixel driving of FIG. 6 is similar to the pixel driving shown in FIG. 3 and will not be omitted.

Referring to FIG. 6, the pixel 100′ according to another exemplary embodiment is similar to the pixel shown in FIG. 3 such that only the differences from the pixel driving circuit of FIG. 3 will be described hereafter. The pixel 100′ according to the exemplary embodiment of FIG. 6 includes the organic light emitting diode (OLED), a first capacitor C1, a second capacitor C2, a first switch P4, a second switch P2, a threshold voltage transistor P3, and a driving transistor P1.

The first capacitor C1 and the second capacitor C2 are separate and connected between a gate electrode of the driving transistor P1 and a drain electrode of the second switch P2. That is, a first terminal of the first capacitor C1 is connected to a node N20, and a second terminal of the first capacitor C1 is connected to a node N10 connected to the gate electrode of the driving transistor P1. A first terminal of the second capacitor C2 is connected to the node N20 and a second terminal of the second capacitor C2 is connected to a source electrode of the driving transistor P1.

Accordingly, the first capacitor C1 and the second capacitor C2 control the change of the voltage value of the gate electrode of the driving transistor P1 when the second switch P2 is turned on in response to the scan signal Scan[n] such that the voltage according to the data signal Data[t] is applied.

The threshold voltage transistor P3 has a gate electrode connected to the controlling line of the threshold voltage and receiving the threshold voltage control signal, the source electrode connected to the node N10, and the drain electrode connected to between the drain electrode of the driving transistor P1 and the anode of the organic light emitting diode (OLED). The threshold voltage control signal GC[t] may be transmitted as the gate on voltage level to turn on the threshold voltage transistor P3, i.e., as the low level. When the threshold voltage transistor P3 is turned on, the threshold voltage of the driving transistor P1 is charged.

The first switch P4 included in the plurality of pixels 100 of the display unit sequentially receives the detection signals Sense[1]-Sense[n] at the low level during the driving voltage sensing and data compensation period T10, and is thereby turned on sequentially. When the scan signals Scan[1]-Scan[n] transmitted to the second switch P2 included in the plurality of pixels and the threshold voltage control signals GC[1]-GC[n] transmitted to the threshold voltage transistor P3 included in the plurality of pixels are both high, the second switch P2 and the threshold voltage transistor P3 are turned off. Accordingly, the driving transistor P1 of the plurality of pixels is also turned off.

Thus, during the period T10, the predetermined first current is supplied to the organic light emitting diode (OLED) in the image compensator of the organic light emitting diode (OLED) display through the turned on first switch P4 of the plurality of pixels. The current driving voltage of the organic light emitting diode (OLED) corresponding to the first current is applied to the data lines corresponding to the pixels while passing from the source electrode to the drain electrode of the first switch P4 of the plurality of pixels. As described above, the driving voltage of the organic light emitting diode (OLED) transmitted to the image compensator 70 through the data lines reflects the deterioration degree of the organic light emitting diode (OLED) of the current, and the image compensator 70 determines the data voltage compensation amount corresponding to the light emitting that is decreased by the deterioration in real time.

During the reset period T11, the scan signals Scan[1]-Scan[n] are low, turning on the second switch P2 of the plurality of pixels, and the threshold voltage control signals GC[1]-GC[t] are high, turning off the threshold voltage transistor P3. If the data voltage according to the data signal transmitted during the reset period T11 is determined as the predetermined appropriate voltage value, the charges accumulated to the anode of the organic light emitting diode (OLED) are quickly discharged such that the driving voltage of the driving transistor P1 is reset.

During the threshold voltage compensation period T12 after the reset period, the threshold voltage control signals GC[1]-GC[t] and the scan signals Scan[1]-Scan[n] are both low, such that the second switch P2 and the threshold voltage transistor P3 of the plurality of pixels are turned on. If the threshold voltage transistor P3 of the plurality of pixels is turned on, the driving transistor P1 of the plurality of pixels is diode-connected such that the gate electrode of the driving transistor P1 receives a lower voltage than the threshold voltage from the source voltage. Accordingly, the capacitor C1 is charged with the voltage corresponding to the threshold voltage of the driving transistor P1.

During the light emitting period T14, the second switch P2 of the plurality of pixels is turned on by the corresponding scan signal during the light emitting period such that the voltage of the gate electrode of the driving transistor P1 of the plurality of pixels is boosted by the transmitted data voltage. Accordingly, the voltage of the gate electrode of the driving transistor P1 is applied with the data voltage of which the threshold voltage is compensated. The organic light emitting diode (OLED) of the plurality of pixels emits the light according to the driving current generated according to the voltage difference between the gate electrode and the source electrode of the driving transistor P1.

As described above, embodiments relate to an organic light emitting diode (OLED) display having improved reliability in terms of image quality characteristics by compensating image sticking in real time as a frame unit in a process of driving each pixel of the organic light emitting diode (OLED) display.

Also, as described above, embodiments relate a pixel driving circuit controlling for external compensation by sensing a driving voltage of an organic light emitting diode (OLED) of the organic light emitting diode (OLED) display, and easily changes timing of a power source voltage and a driving signal in accordance with the sensed driving voltage.

As described above, embodiments relate to an organic light emitting diode (OLED) display that improves reduction in life-span due to deterioration of the organic light emitting diode (OLED), thereby providing the organic light emitting diode (OLED) display having excellent quality characteristics.

<Description of symbols>

| | |
|---|---|
| 10: display unit | 20: scan driver |
| 30: data driver | 40: light emission control driver |
| 50: sensing driver | 60: timing controller |
| 70: image compensator | 80: data selection unit |
| 100, 100′: pixel | |

While this invention has been described in connection with what is presently considered to be exemplary embodiments, it is to be understood that the invention is not limited to the disclosed embodiments. A person having ordinary skill in the art can change or modify the described embodiments without departing from the scope of the present invention, and it will be understood that the present invention should be construed to cover the modifications or variations. Further, the material of each of the constituent elements described in the specification can be readily selected from among various known materials and replaced thereby by a person having ordinary skill in the art. Further, a person having ordinary skill in the art can omit some of the constituent elements described in the specification without deteriorating performance or can add constituent elements in order to improve performance. In addition, a person having ordinary skill in the art may change the sequence of the steps described in the specification according to process environments or equipment. Accordingly, the scope of the present invention should be determined not by the above-described exemplary embodiments, but by the appended claims and their equivalents.

What is claimed is:

1. An organic light emitting diode (OLED) display, comprising:
an organic light emitting diode (OLED);
a driving transistor supplying a driving current to the organic light emitting diode (OLED);
a data line transmitting a data signal to the driving transistor;
a first switch including a first electrode connected to one electrode of the organic light emitting diode (OLED) and a second electrode connected to the data line; and
a second switch including a first electrode connected to the data line and a second electrode connected to a gate electrode of the driving transistor,
wherein the first switch is configured to be turned on such that a predetermined first current is transmitted to the organic light emitting diode (OLED), the voltage of one electrode of the organic light emitting diode (OLED) is received through the data line, the deterioration degree of the organic light emitting diode (OLED) is detected according to the transmitted voltage, and the data signal transmitted to the data line is compensated according to the detected deterioration.

2. The organic light emitting diode (OLED) display as claimed in claim 1, wherein:
a period for turning on the first switch is a predetermined period among one frame period, and
one frame period includes a reset period for resetting a driving voltage of the organic light emitting diode (OLED), a threshold voltage compensation period for compensating a threshold voltage of the driving transistor, a data writing period for transmitting a data voltage according to the data signal, and a light emitting period in which the organic light emitting diode (OLED) emits light.

3. The organic light emitting diode (OLED) display as claimed in claim 2, wherein the predetermined period is before the reset period.

4. The organic light emitting diode (OLED) display as claimed in claim 1, wherein the second switch and the driving transistor are turned off during a period in which the first switch is turned on.

5. The organic light emitting diode (OLED) display as claimed in claim 1, further comprising:
an image compensator configured to receive the voltage of the first electrode of the organic light emitting diode (OLED) through the data line; and
a selection switch between the data line and the image compensator, the selection switch being configured to be turned on by the selection signal so as to transmit the voltage of the first electrode to the image compensator.

6. The organic light emitting diode (OLED) display as claimed in claim 1, wherein the second switch is configured to be turned on during a reset period for resetting the driving voltage of the organic light emitting diode (OLED) and during a threshold voltage compensation period for compensating the threshold voltage of the driving transistor among one frame period.

7. The organic light emitting diode (OLED) display as claimed in claim 1, further comprising:
a storage capacitor including a first terminal connected to the gate electrode of the driving transistor and a second terminal connected to the first electrode of the organic light emitting diode (OLED),
wherein the storage capacitor charges a data voltage during a data writing period in which the second switch is turned on such that the data voltage according to the data signal is transmitted among one frame period.

8. The organic light emitting diode (OLED) display as claimed in claim 1, further comprising:
a third switch including a first electrode connected to a first power source voltage and a second electrode connected to a source electrode of the driving transistor,
wherein the third switch is configured to be turned on during a reset period for resetting a driving voltage of the organic light emitting diode (OLED), a threshold voltage compensation period for compensating a threshold voltage of the driving transistor, and a light emitting period in which the organic light emitting diode (OLED) emits light among one frame period.

9. The organic light emitting diode (OLED) display as claimed in claim 1, further comprising:
a threshold voltage transistor including a first electrode connected to the gate electrode of the driving transistor and a second electrode connected to a source electrode of the driving transistor,
wherein the threshold voltage transistor is turned on during the threshold voltage compensation period for compensating the threshold voltage of the driving transistor among one frame period.

10. An organic light emitting diode (OLED) display, comprising:
a plurality of pixels respectively including an organic light emitting diode (OLED);
a plurality of data lines transmitting data signals to corresponding pixels of the plurality of pixels; and
an image compensator receiving respective driving voltages of the plurality of organic light emitting diodes (OLED) through the corresponding data lines during a period in which a predetermined first current flows in the plurality of organic light emitting diodes (OLED),
wherein the image compensator is configured to determine a deterioration degree of the plurality of organic light emitting diodes (OLED) according to the transmitted driving voltage and compensate the data signals transmitted to the plurality of pixels according to the determined deterioration degree.

11. The organic light emitting diode (OLED) display as claimed in claim 10, further comprising a sensing driver configured to generate and transmit a detection signal corresponding to a plurality of sensing lines connected to the plurality of pixels, wherein the plurality of pixels transmit the predetermined first current in response to the detection signal and include a first switch transmitting the driving voltage of the organic light emitting diode (OLED).

12. The organic light emitting diode (OLED) display as claimed in claim 11, wherein:
the first switch is turned on during a predetermined period among one frame period; and
one frame period includes a reset period for resetting the driving voltage of the organic light emitting diode (OLED), a threshold voltage compensation period for compensating a threshold voltage of the driving transistor, a data writing period for transmitting the data voltage according to the data signal, and a light emitting period in which the organic light emitting diode (OLED) emits light.

13. The organic light emitting diode (OLED) display as claimed in claim 12, wherein the predetermined period is before the reset period.

14. The organic light emitting diode (OLED) display as claimed in claim 10, wherein each of the plurality of pixels includes:
a second switch transmitting a compensated data signal through a corresponding data line among the plurality of data lines;
a driving transistor supplying a driving current according to the compensated data signal to the organic light emitting diode (OLED); and
a third switch positioned between a first power source voltage and the driving transistor and controlling light emission of the organic light emitting diode (OLED).

15. The organic light emitting diode (OLED) display as claimed in claim 10, wherein each of the plurality of pixels includes:
a second switch transmitting a compensated data signal through a corresponding data line among the plurality of data lines;
a driving transistor supplying a driving current according to the compensated data signal to the organic light emitting diode (OLED); and
a threshold voltage transistor diode-connecting the driving transistor to charge a threshold voltage of the driving transistor to a capacitor connected to the gate electrode of the driving transistor.

16. The organic light emitting diode (OLED) display as claimed in claim 14 or claim 15, wherein each of the plurality of pixels includes a storage capacitor connected between the gate electrode and a source electrode of the driving transistor, wherein the storage capacitor charges the data voltage corresponding to the compensated data signal during a period in which the second switch is turned on among one frame period.

17. The organic light emitting diode (OLED) display as claimed in claim 15, wherein the second switch is turned on during a reset period for resetting the driving voltage of the organic light emitting diode (OLED) and a threshold voltage compensation period for compensating the threshold voltage of the driving transistor among one frame period.

18. The organic light emitting diode (OLED) display as claimed in claim 10, further comprising a data selection unit including a selection switch connected to the data lines respectively connected to the plurality of pixels and selecting a path of the voltage transmitted through the data lines, wherein the selection switch is configured to be turned on by a selection signal so as to transmit the driving voltage of the organic light emitting diode (OLED) to the image compensator.

19. A method for driving an organic light emitting diode (OLED) display including a plurality of pixels respectively including a plurality of organic light emitting diodes (OLED), a plurality of data lines transmitting a data signal corresponding to the plurality of pixels, and an image compensator receiving respective driving voltages of the plurality of organic light emitting diodes (OLED) through corresponding data lines during a period in which a predetermined first current flows in the plurality of organic light emitting diodes (OLED), the method comprising:
receiving the driving voltage of the plurality of organic light emitting diodes (OLED) through the data lines;
determining a deterioration degree of the plurality of organic light emitting diodes (OLED) according to the transmitted driving voltage; and
compensating the plurality of data signals transmitted to the plurality of pixels according to the determined deterioration degree.

20. The method as claimed in claim 19, wherein:
receiving, determining, and compensating are executed during a predetermined period of one frame period; and
one frame period includes:
a reset period for resetting the driving voltage of the organic light emitting diode (OLED),
a threshold voltage compensation period for compensating the threshold voltage of the driving transistor,
a data writing period for transmitting the data voltage according to the data signal, and
a light emitting period in which the organic light emitting diode (OLED) emits light.

21. The method as claimed in claim 20, wherein the predetermined period is before the reset period.

22. The method as claimed in claim 19, further comprising turning on a first switch of the plurality of pixels flowing a first predetermined current to the organic light emitting diode (OLED) included in the plurality of pixels and transmitting the driving voltage of the organic light emitting diode (OLED) to the corresponding data line during a period in which the receiving, determining, and compensating are executed.

23. The method as claimed in claim 22, wherein the pixels include a second switch transmitting a compensated data signal through the corresponding data line among the plurality of data lines, a driving transistor supplying a driving current according to the compensated data signal to the organic light emitting diode (OLED), and a third switch positioned between a first power source voltage and the driving transistor and controlling light emission of the organic light emitting diode (OLED), the method further comprising:
turning off the second switch, the driving transistor, and the third switch during the period in which the receiving, determining, and compensating are executed.

24. The method as claimed in claim 22, wherein the plurality of pixels include a second switch transmitting a compensated data signal through the corresponding data line among the plurality of data lines, a driving transistor supplying a driving current according to the compensated data signal to the organic light emitting diode (OLED), and a threshold voltage transistor diode-connecting the driving transistor to charge a threshold voltage of the driving transistor to a capacitor connected to the gate electrode of the driving transistor, the method further comprising:
turning off the second switch, the driving transistor, and the threshold voltage transistor during the period in which the receiving, determining, and compensating are executed.

25. The method as claimed in claim 23 or claim 24, wherein each of the plurality of pixels include a storage capacitor connected between the gate electrode and the source electrode of the driving transistor, the method comprising:
charging the data voltage corresponding to the compensated data signal in the storage capacitor when the second switch is turned on.

26. The method as claimed in claim 24, comprising turning on the second switch during the reset period for resetting the driving voltage of the organic light emitting diode (OLED) and the threshold voltage compensation period for compensating the threshold voltage of the driving transistor among one frame period.

27. The method as claimed in claim 19, wherein the organic light emitting diode (OLED) display includes a data selection unit including a selection switch connected to the data lines respectively connected to the plurality of pixels and selecting a path of the voltage transmitted through the data lines, the method comprising:
turning on the selection switch by a selection signal such that the driving voltage of the organic light emitting diode (OLED) is transmitted to the image compensator.
